(19) United States
(12) Patent Application Publication
(10) Pub. No.: US 2026/0006516 A1
(43) Pub. Date: Jan. 1, 2026

(54) NETWORK SLICE BASED CELL RESELECTION

(71) Applicant: Nokia Technologies Oy, Espoo (FI)

(72) Inventors: Sreekumar POTHERA KALLOOR, Bangalore (IN); Stephen MWANJE, Munich (DE)

(21) Appl. No.: 19/125,178

(22) PCT Filed: Oct. 27, 2023
(86) PCT No.: PCT/EP2023/080087

§ 371 Date: Apr. 28, 2025

(30) Foreign Application Priority Data
Nov. 3, 2022 (IN) 202241062937

(51) Int. Cl. H04W 36/00; H04W 36/26

(52) U.S. Cl. CPC H04W 36/13; H04W 36/00837; H04W 36/26

(57) ABSTRACT

Example embodiments of the present disclosure relate to enhancements on network slicing. A first device generates preference information on service and slice prioritization for a slice-based cell reselection. The first device then transmits the preference information to a second device serving the first device with a slice. In this way, a communications service customer (CSC) defines an intent on the cell reselection priority at a slice level. The intent is provided to a communications service provider (CSP), and then pass to the domain orchestrator and network optimization functions for provisioning network elements associated with the slice-based cell reselection. As such, the cell reselection related to UEs belonging to different slices can be performed at a slice level or at a service level, and thus each of the UEs can latch on to a suitable frequency layer, which reduces unnecessary handovers.

### FIELD

Various example embodiments of the present disclosure generally relate to the field of telecommunication and in particular, to methods, devices, apparatuses and computer readable storage medium for network slice-based cell reselection.

### BACKGROUND

In 5G network, management of network slices involves the interaction between Communication Service Customer (CSC), Communication Service provider (CSP), Domain Orchestrator(s), Network Optimization, Network Management, and the access network and/or core network and/or transport network. These functional entities collectively provide capabilities for end-to-end management of network slices including creation, modification, supervision and termination of the network slices.

End to end management of the network slices defined by the third-generation partnership project (3GPP) specification on management and orchestration of networks handles some of the capabilities and characteristics expected from each network slice, covering the creation of the network slice or the modification of the network slice. The creation of the network slice is initiated by the CSC which provides the requirements of the new slices to the CSP. Similarly, the modification of the capabilities and characteristics on the network slice can be initiated by the CSC and passed to the CSP. The CSP may further propagate the requirements to the network elements via domain orchestration, network optimization and/or network management functions.

### SUMMARY

In general, example embodiments of the present disclosure provide a solution of network slice-based cell reselection.

In a first aspect of the present disclosure, there is provided a first device. The first device comprises at least one processor: and at least one memory storing instructions that, when executed by the at least one processor, cause the first device at least to perform: generating, at the first device served by a second device with a slice, preference information on service and slice prioritization for a slice-based cell reselection: and transmitting the preference information to the second device.

In a second aspect of the present disclosure, there is provided a second device. The second device comprises at least one processor: and at least one memory storing instructions that, when executed by the at least one processor, cause the second device at least to perform: receiving, from a first device served by a slice of the second device, preference information on service and slice prioritization for a slice-based cell reselection: generating, based on the preference information, configuration information indicating the service and slice prioritization: and transmitting the configuration information to a third device for configuring the slice-based cell reselection.

In a third aspect of the present disclosure, there is provided a third device. The third device comprises at least one processor: and at least one memory storing instructions that, when executed by the at least one processor, cause the third device at least to perform: receiving, from a second device serving a first device with a slice, configuration information indicating service and slice prioritization for a slice-based cell reselection: generating, based on the configuration information, at least one parameter related to the service and slice prioritization: and transmitting the at least one parameter to at least one network device associated with the slice-based cell reselection.

In a fourth aspect of the present disclosure, there is provided a method. The method comprises: generating, at a first device served by a second device with a slice, preference information on service and slice prioritization for a slice-based cell reselection: and transmitting the preference information to the second device.

In a fifth aspect of the present disclosure, there is provided a method. The method comprises: receiving, at a second device and from a first device served by a slice of the second device, preference information on service and slice prioritization for a slice-based cell reselection: generating, based on the preference information, configuration information indicating the service and slice prioritization: and transmitting the configuration information to a third device for configuring the slice-based cell reselection.

In a sixth aspect of the present disclosure, there is provided a method. The method comprises: receiving, at a third device and from a second device serving a first device with a slice, configuration information indicating service and slice prioritization for a slice-based cell reselection: generating, based on the configuration information, at least one parameter related to the service and slice prioritization: and transmitting the at least one parameter to at least one network device associated with the slice-based cell reselection. In a seventh aspect of the present disclosure, there is provided a first apparatus. The first apparatus comprises: means for generating, at the first apparatus served by a second apparatus with a slice, preference information on service and slice prioritization for a slice-based cell reselection: and means for transmitting the preference information to the second apparatus.

In an eighth aspect of the present disclosure, there is provided a second apparatus. The second apparatus comprises: means for receiving, from a first apparatus served by a slice of the second apparatus, preference information on service and slice prioritization for a slice-based cell reselection: means for generating, based on the preference information, configuration information indicating the service and slice prioritization: and means for transmitting the configuration information to a third apparatus for configuring the slice-based cell reselection.

In a nineth aspect of the present disclosure, there is provided a third apparatus. The third apparatus comprises: means for receiving, from a second apparatus serving a first apparatus with a slice, configuration information indicating service and slice prioritization for a slice-based cell reselection: means for generating, based on the configuration information, at least one parameter related to the service and slice prioritization: and means for transmitting the at least one parameter to at least one network device associated with the slice-based cell reselection.

In a thirteenth aspect of the present disclosure, there is provided a computer readable medium. The computer readable medium comprises instructions stored thereon for causing an apparatus to perform at least the method according to any of the fourth aspect, the fifth aspect, or the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented:

FIG. 2 illustrates a signaling chart for network slice-based cell reselection according to some example embodiments of the present disclosure:

FIG. 3 illustrates a flowchart of a method implemented at a first device according to some example embodiments of the present disclosure:

FIG. 4 illustrates a flowchart of a method implemented at a first device according to some example embodiments of the present disclosure:

FIG. 5 illustrates a flowchart of a method implemented at a third device according to some example embodiments of the present disclosure:

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, “at least one of the following: <a list of two or more elements>and “at least one of <a list of two or more elements>and similar wording, where the list of two or more elements are joined by “and” or “or”, means at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
   (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a Next Generation NodeB (NR NB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

As used herein, the term “control device” refers to any entity/function/device/apparatus for control. In some example embodiments, the control device is device used for implementing domain orchestration, network optimization and network management functions and so on.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

In 5G, network deployment typically consists of multiple frequency layers to cater different coverage, capacity and mobility requirements with each of the frequency layers fulfilling the different requirements. The performance of the network on these requirements may vary across different frequency layers. In an example scenario, the network slice catering to business related to Internet of everything (IoT) devices deployed insider buildings and basement expects the network coverage to be prioritized at the highest level considering that any loss of the network coverage may impact the operation of these devices. Similarly, in another example scenario where the user devices are confined to a stadium where the user expects high upload and/or download throughput and most of the user devices are connected to small cells, the layer prioritization should be done to meet these requirements.

The layer specific requirements may be different for different slices based on the actual expectations from the slice and hence it is important to consider these layer specific differentiation requirements for different slices while creating and modifying a slice.

For the creation and modification of network slices, as part of end-to-end network slice life cycle management, the CSC specifies slice configuration requirements including, but not limited to the slice type, latency, throughput, UE mobility level, etc. as part of a service profile. These configuration requirements are processed by the CSP, domain orchestrator, network optimization and network management functions, and finally provisioned to the core network (CN) and/or radio access network (RAN).

In particular, newly created slices are configured with slice level parameters which are defined in “ServiceProfile” and “SliceProfile” objects. Input from CSC on network slice level requirements is provided as part of the “ServiceProfile” object, which is passed on to the CSP. The CSP processes the requirements in “ServiceProfile” object and creates the “SliceProfile” object for different domains with the corresponding parameter settings. The CSP then invokes the domain orchestrator for passing the “SliceProfile” object.

After receiving the “SliceProfile” object, the domain orchestrator processes these requirements and pass them further to the network optimization function and network management functions to provision the changes to the network with the right slice level parameter configurations.

Apart from the slice specific configurations which are applicable per slice, there are common configurations applicable at a network element level (e.g., cell level) and at a network level which are applicable for all the network slices configured under the network element.

One of such parameters is the cell reselection configuration parameter. Currently, the network considers common reselection criteria for all the network slices in the network. In this case, the network layer (i.e., the frequency layer) configuration for cell reselection is handled at the network element level, and thus applicable for all the slices under that network element. In the above example scenarios, if the network slice for IoT devices and the network slice for the user devices are configured in the same network, the IoT devices and the user devices follow the same priority of NR frequencies for cell reselection configured via SIB information.

Typically, the terminal device (including but not limited to IoT devices, UE, and so on) camps on to a frequency layer with the highest priority set at cell level or slice level. However, the default layer selected for a particular slice may not be the best suited to handle specific requirements for that slice. As a result, the terminal device will need reconnection or handover to recover from requirement issues and to get the expected network performances. This would cause

In view of the above, it is desirable to provision the initial configuration for the network layer prioritization suited for each slice to ensure that the slice user latches on to the desired network layer to get the expected network performances from the first instance without the need to reconnections.

In order to solve the above issue as well as other potential issues, the present disclosure provides a solution for network slice-based cell reselection, which is driven by an intent or expectation from CSC and CSP. In this solution, the CSC provides an intent on priorities of slice performance to the domain orchestrator and network optimization functions via the CSP. the intent represents a preference of cell reselection priority at a slice level. Hence, the intent can be used to configure the priorities of frequency layers for network slices in a cell. In this way, the idle mode cell reselection is enabled at network slice level, and unnecessary handovers can be avoided.

### Example Environment

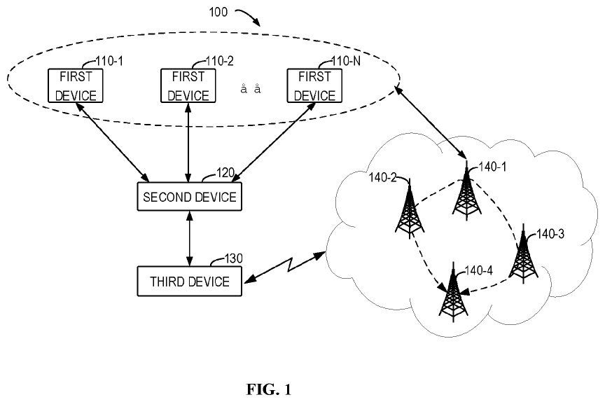

FIG. 1 illustrates an example communication environment 100 in which example embodiments of the present disclosure can be implemented. The communication environment 100 may be a communication system supporting network slicing. As shown in FIG. 1, the communication environment 100 includes a plurality of first devices 110-1 to 110-N, a second device 120, a third device 130, and a plurality of fourth devices 140-1 to 140-4.

The network deployment in communication environment 100 consists of multiple frequency layers to meet various requirements. The plurality of first devices 110-1 to 110-N (which may be collectively called first device 110) are end users of network slices which provide various communication services, such as, enhanced mobile broadband (eMBB), ultra-reliable, low latency communications (URLLC), massive machine type communications (mMTC), and so on. In the context of the present disclosure, the first device 110 may be also referred to as CSC 110.

The plurality of first devices 110-1 to 110-N may vary from requirements of network performances, including but not limited to, coverage, capacity, slice type, a mobility level, latency, throughput and so on. By way of example, the first device 110-1 belongs to mobile broadband user category, and the first device 110-2 belongs to a service proving mining area. Thus, among other network performances, the first device 110-1 may expect the network capacity to be prioritized, while the first device 110-2 may expect the network coverage to be prioritized.

To achieve the expected network performances, an initial configuration for the network layer prioritization for each network slice shall ensure that CSC latches on to the desired network layer.

The second device 120 may be a network orchestrator implementing end to end management of network slices, which may be also referred to as the CSP 120 hereinafter. The second device 120 may handle the creation and modification of network slices. The creation of a network slice may be initiated by the CSC which provides the requirements of the new slices to the CSP. Similarly, the modification of the capabilities and characteristics on the network slice may be initiated by the CSC and transmitted the CSP. The CSP may then propagate the requirements to the CN and/or RAN via domain orchestration, network optimization and/or network management functions.

The third device 130 may be a network controller implementing domain orchestration, network optimization and/or network management functions. In some example embodiments, these functions may be implemented by a single device. Alternatively, in some other embodiments, these functions may be implemented by separate devices, and in this case, the domain orchestrator may process the requirements and pass to the network optimization function and network management functions to provision network devices in CN and/or RAN. Thus, the embodiments of the present disclosure are not limited in this regard.

The fourth devices 140-1 to 140-4 are network devices that provide communication services and network slices for the first device 110, which may be collectively referred to as fourth device 140 hereinafter. By way of example, the first devices 110-1 to 110-N may camp on the fourth device 140-1, and in particular, on a frequency layer with the highest priority set at cell level or slice level. The first device 110 may then reconnect or handover to another fourth device 140 based on the received signal strength and quality and cell reselection criteria. In some example embodiment, the cell reselection configuration may be configured at the slice level or at the service level, which will be discussed in detail later.

It is to be understood that the number of devices and their connections shown in FIG. 1 are only for the purpose of illustration without suggesting any limitation. The communication network 100 may include any suitable number of devices configured to implementing example embodiments of the present disclosure. Although not shown, it would be appreciated that one or more additional devices and connections may be deployed in the communication network 100.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

According to some example embodiments of the present disclosure, there is provided a solution of intent driven network slice-based cell reselection. In this solution, the CSC can provide expectations in terms of network performances as part of an intent exposed by the CSP. The expectations or the intent enables the communication system to achieve the slice level cell reselection criteria.

Example embodiments of the present disclosure will be described in detail below with reference to the accompanying drawings.

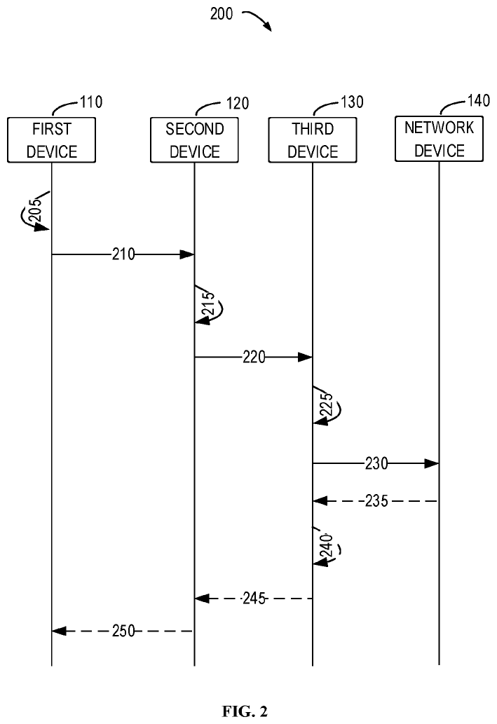

Reference is now made to FIG. 2, which illustrates a signaling chart for intent driven network slice-based cell reselection according to some example embodiments of the present disclosure. As shown in FIG. 2, the process 200 involves the first device 110, the second device 120, the third device 130 and the fourth device 140. For the purpose of discussion, reference is made to FIG. 1 to describe the signaling flow 200.

In the process 200, the first device 110 generates 205 preference information on service and slice prioritization for a slice-based cell reselection.

The preference information may be related to expectations on the slice-based cell reselection criteria. In particular, the preference information may indicate a preference for cell selection priorities based on at least one requirement for network performance. For example, the at least one requirement may include, but not limited to a slice coverage, a network capacity, a slice type, mobility, latency, throughput and so on.

In some example embodiments, the preference information may comprise a set of values indicating a preference for cell selection priorities based on a plurality of requirements. In particular, a set of priority values (e.g., integer values) may be defined for a plurality of requirements, such as, the radio coverage, the network capacity, the slice type, mobility, latency, throughput and so on. As an example implementation, the priorities of the plurality of requirements may increase as the priority values decrease, that is, the lower the priority value is, the higher the priority value is, the lower priority the requirement has. As another implementation, the priorities of the plurality of requirements may increase as the priority values increase, that is, the higher the priority value is, the higher priority the requirement has.

Additionally, or alternatively, before generating the preference information at 205, first device 110 may identify slice level requirements in terms of radio coverage, a network capacity, a slice type, mobility, latency, throughput, and so on. The first device 110 may the determine whether the slice-based cell reselection is required based on the slice level requirements. If so, the first device 110 may generate the preference information as an intent definition with the reselection criteria. Otherwise, the cell reselection configuration may be provided at network element level which are applicable for all the network slices configured under the same network element.

The first device 110 transmits 210 the preference information to the second device 120. A format of the preference information may be commonly agreed among the CSC, CSP and the network controller, since the first device 110 may have less knowledge on the network internals and how the idle mode reselection works.

To this end, the second device 120 may expose ways by which the first device 110 is able to provide input on the slice-based cell reselection criteria. In some example embodiments, the expectation from CSC (i.e., the first device 110) on slice-based cell reselection criteria may include slice coverage requirements, capacity requirement, mobility requirements, etc., in human understandable format. This may be achieved by an intent driven approach in which the CSP (i.e., the second device 120) acts as an “intent driven management service (MnS) producer” and exposes an intent interface towards the CSC which acts as an “intent driven MnS consumer”. In this way, the CSC can provide the expectations which may be in the form of “intent” object.

Reference is made to FIG. 1, where the first device 110-1 belongs to mobile broadband user category that expects the network capacity to be prioritized, while the first device 110-2 belongs to a service proving mining area that expects the network coverage to be prioritized. That is, the reselection requirements for the network slices for the first devices 110-1 and 110-2 are different. By way of example, the reselection requirements for the network slices for the first device 110-1 are passed to the interface provided by the CSP depicted with a sequence of network devices 140-1, 140-3 and 140-4. In addition, the reselection requirements for the network slices for the first device 110-2 are passed to the interface provided by the CSP depicted with a sequence of network devices 140-1, 140-2 and 140-4.

After receiving the preference information, the second device 120 generates 215, based on the preference information, configuration information indicating the service and slice prioritization. In some example embodiments, the configuration information may indicate a preference for cell selection priorities based on at least one requirement for network performance. For example, the at least one requirement may include, but not limited to a radio coverage, a network capacity, a slice type, mobility, latency, throughput, and so on.

In some example embodiments, the configuration information may comprise a set of values indicating a preference for cell selection priorities based on a plurality of requirements. In particular, a set of priority values (e.g., integer values) may be defined for a plurality of requirements, such as, the radio coverage, the network capacity, the slice type, mobility, latency, throughput and so on. As an example implementation, the priorities of the plurality of requirements may increase as the priority values decrease, that is, the lower the priority value is, the higher priority the requirement has. As another implementation, the priorities of the plurality of requirements may increase as the priority values increase, that is, the higher the priority value is, the higher priority the requirement has.

In some example embodiments, the second device 120 may provide the configuration information which includes slice coverage requirements, capacity requirement, mobility requirements etc. or additionally or alternatively, the information enriched with additional input which can be understood and processed by the third device 130.

The second device 120 transmits 220 the configuration information to a third device for configuring the slice-based cell reselection. To this end, the third device 130 may provide a mechanism by which the second device 120 can provide input on the expectations on slice-based cell reselection priorities which is in a format understood by the second device 120. Similarly, this may be achieved by the intent driven approach in which the network controller for implementing the domain orchestrator and/or network optimization functions acts as the MnS provider and exposes the intent interface towards the CSP. Accordingly, the CSP can provide the expectations which may be in the form of “Intent” object.

The third device 130 generates 225, based on the configuration information, at least one parameter related to the service and slice prioritization. The at least one parameter may include, for example, a slice specific cell reselection priority (e.g., sliceSpecificCellReselectionPriority), a frequency priority list for NR slicing (e.g., FreqPriorityListNRSlicing), and so on. Additionally, or alternatively, the at least one parameter may comprise the priority values defined for the at least one requirement, such as the radio coverage, the network capacity, the slice type, mobility, latency, throughput and so on.

In some example embodiments, the third device 130 may map the configuration information representing the expectations from the second device 120 to a format understood by network elements in CN and/or RAN, for example, the fourth device 140. For example, this may be implemented by an entity of slice-based cell reselection mapper.

In some example embodiments, the third device 130 may provide a mechanism to translate the intent/expectations received from the second device to a format understood by the network elements which may be in the form of managed object model exposed by the corresponding network elements.

In some example embodiments, handling of the intent expectations for individual slices and identifying the relevant network parameters to have slice level frequency layer prioritization may be implemented by domain orchestrator or network optimization function.

The third device 130 then transmits 230 the at least one parameter to at least one network device associated with the slice-based cell reselection. In this way, the at least one network device (e.g., the fourth device 140) may be provisioned with updated network parameters.

Additionally, in some example embodiments, the third device 130 may obtain 235 a provisioning status of cell reselection priorities at a service level or at a slice level. In this case, the third device 130 may generate 240 a report of a provisioning status of cell reselection priorities at a service level or at a slice level. For example, the report may indicate a success of differentiation/selection. In some example embodiments, the generation of the report may be implemented by an entity of “report generator” under the third device 130.

The third device 130 may then transmit 245 the report to the second device 120. Accordingly, the second device 120 may then 250 forward the report to the first device 110.

As a result, the configuration of frequency layer prioritization at slice level enables the terminal devices belonging to different slice to latch on to the suitable frequency layer at reselection. The cell at the suitable frequency layer is best suited to handle, for example, coverage, capacity and mobility requirements for corresponding use categories. In this way, the communication performance can be improved, while unnecessary handover can be avoided.

It should be understood that some of the steps in process 200 are optional or can be omitted, and the order of the steps is given for an illustrative purpose. Thus, the embodiments of the present disclosure are not limited in this regard.

The example descriptions on the embodiments of the present disclosure as well as possible standardization impacts and information model in the standards are shown as below. However, it should be understood that the details, values, configurations in the following description are given as example implementations, not limitations to the embodiments of the present disclosure.

### 5 USE CASES AND POTENTIAL REQUIREMENTS

### 5.A Intent Driven Network Slice-Based Cell Reselection

### 5.A.1 Description

Intent driven slice-based cell reselection MnS Producer interface exposed by the Communication Service Provider receives the intent expectations on cell reselection priority at slice level/service level from Communication Service Customer.

Intent driven slice-based cell reselection MnS Producer interface exposed by the Network Management and Optimization function receives the intent expectations on the cell reselection priority at slice level/service level from Communication Service Provider.

Intent reporting provided by Network Management and Optimization function provides the status on the enforcement on the cell reselection priority at slice level/service level.

### 5.A.2 Details

Intent driven network slice-based cell reselection provide option for Communication Service Customer to defines the network expectations in terms of priority to coverage/capacity/mobility/latency as part of the intent exposed by Communication Service Provider. Communication Service Provider as the MnS Producer, process the intent expectation provided by the Communication Service Customer. Communication Service Provider as the MnS Consumer for Network Management and Optimization functions and prepare the intent objects to be processed further by these functions. Network Management and Optimization functions further process these intents and translate the expectations expressed by the intent to the network parameters which is understood by the network elements there by enforcing the expectations defined by the Communication Service Customer.

### 5.A.3 Potential Requirements

REQ-Intent_Resel-CON-1: The 3GPP management system shall have the capability enabling MnS consumer of Intent Driven Service Management to express the intent on cell selection priorities on frequency layers for a specific service

REQ-Intent_Resel-CON-2: The intent driven MnS Producer in the Communication Service Provider shall have the capability enabling MnS consumer to express the intent on cell selection priorities on frequency layers for a specific slice

REQ-Intent_Resel-CON-3: The 3GPP management system shall have the capability enabling MnS consumer of Intent Driven Slice Management to express the intent on cell selection priorities on frequency layers for a specific slice

REQ-Intent_Resel-CON-4: The intent driven MnS Producer in the Network Management and Optimization shall have the capability enabling MnS consumer to express intent on cell selection priorities on frequency layers for a specific slice

REQ-Intent_Resel-CON-5: Network Management and Optimization shall have the capability reporting the status on the enforcement on the cell selection priority for a specific slice

### 6.2.2 SCENARIO SPECIFIC INTENTEXPECTATION DEFINITION

### 6.2.2.1.N Service and Slice Prioritisation Expectation

### 6.2.2.1.N.1 Definition

Service and slice Prioritisation Expectation is an IntentExpectation which can be used to represent MnS consumer's expectations for service and slice prioritisation.

The Service and slice Prioritisation Expectation is defined utilizing the constructs of the generic IntentExpectation <<dataType>>with set of allowed values and concrete data Types specified.

Following are the specific allowed values when implemented the IntentExpectation for Service and slice Prioritisation Expectation.

TABLE 6.2.2.1.2.1-1

| Attribute | Allowed Values |
|---|---|
| ObjectType (CM) | Service, Network Slice |
| objectInstance (CM) | DN of the Service, DN of the Network Slice |

NOTE:
Following are the qualifier description for attribute “objectType” and “objectInstance”:

In case of the intent expectation is not for a specific service instance or/and MnS consumer have no knowledge of the DN of this service instance, the attribute “objectType” needs to be specified.

In case of the intent expectation is for a specific service instance and MnS consumer have the knowledge of the DN of this service instance, the attribute “objectInstance” needs to be specified.

### 6.2.2.1.N.2 ObjectContexts

None

### 6.2.2.1.N.3 Expectation Targets

Following provides the concrete ExpectationTargets for Service and slice Prioritisation Expectation based on the common structure of ExpectationTarget. The attribute properties defined in the table below should be same with the properties defined for Expectation Targets in clause 6.2.1.3.

TABLE 6.2.2.1.2.3-1

| | Support | | | | |
|---|---|---|---|---|---|
| Attribute Name | Qualifier | isReadable | is Writable | isInvariant | isNotifyable |
| dlThptPerUEPriorityTarget | O | T | T | F | F |
| UlThptPerUEPriorityTarget | O | T | T | F | F |
| dLLatencyPriorityTarget | O | T | T | F | F |
| uLLatencyPriorityTarget | O | T | T | F | F |
| coveragePriorityTarget | O | T | T | F | F |
| uESpeedPriorityTarget | O | T | T | F | F |

### 6.2.2.1.N.4 ExpectationContext

None

### 6.2.2.2 Attribute Definition

TABLE 6.2.2.2-1

| Attribute Name | Documentation and Allowed Values | Properties |
|---|---|---|
| coveragePriorityTarget | It describes the expected priority for | type: Integer |
| | Coverage for the service or slice | multiplicity: 1 |
| | | isOrdered: N/A |
| | | isUnique: N/A |
| | | defaultValue: |
| | | False |
| | | isNullable: True |
| dlThptPerUEPriorityTarget | It describes the expected priority for downlink | type: Integer |
| | UE throughput for the service or slice | multiplicity: 1 |
| | | isOrdered: N/A |
| | | isUnique: N/A |
| | | defaultValue: |
| | | False |
| | | isNullable: True |
| UlThptPerUEPriorityTarget | It describes the expected priority for uplink | type: Integer |
| | UE throughput for the service or slice | multiplicity: 1 |
| | | isOrdered: N/A |
| | | isUnique: N/A |
| | | defaultValue: |
| | | False |
| | | isNullable: True |
| dLLatencyPriorityTarget | It describes the expected priority for | type: Integer |
| | downlink latency for the service or slice | multiplicity: 1 |
| | | isOrdered: N/A |
| | | isUnique: N/A |
| | | defaultValue: |
| | | False |
| | | isNullable: True |
| uLLatencyPriorityTarget | It describes the expected priority for uplink | type: Integer |
| | latency for the service or slice | multiplicity: 1 |
| | | isOrdered: N/A |
| | | isUnique: N/A |
| | | defaultValue: |
| | | False |
| | | isNullable: True |
| uESpeedPriorityTarget | It describes the expected priority for | type: Integer |
| | UE speed for the service or slice | multiplicity: 1 |
| | | isOrdered: N/A |
| | | isUnique: N/A |
| | | defaultValue: |
| | | False |
| | | isNullable: True |

### Example Methods

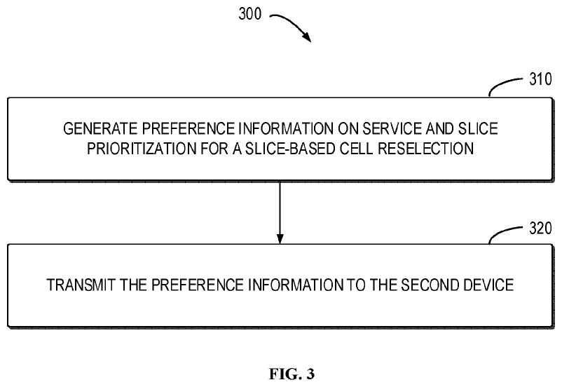

FIG. 3 illustrates a flowchart of a method 300 implemented at a first device according to some example embodiments of the present disclosure. For example, the first device may include a terminal device. For the purpose of discussion, the method 300 will be described from the perspective of the first device 110 in FIG. 1.

At block 310, the first device 110 generates preference information on service and slice prioritization for a slice-based cell reselection. In this case, the first device 110 is served by the second device 120 with a slice. The preference information may indicate a preference for cell selection priorities based on at least one requirement for network performance. For example, the at least one requirement may comprise at least one of the following: a radio coverage, a network capacity, mobility, latency, or throughput.

In some example embodiments, the preference information may comprise a set of values indicating a preference for cell selection priorities based on a plurality of requirements. By way of example, the set of values may be integer values, each of the plurality of requirements is indicated via a corresponding integer value.

The plurality of requirements may be prioritized in one of the following: an ascending order of the set of values or a descending order of the set of values. That is, for the former case, the priorities of the requirements increase as the values increase, and the higher the value is, the higher priority the requirement has. For the latter case, the priorities of the requirements increase as the values decrease, and the lower the value is, the higher priority the requirement has.

In some example embodiments, the slice-based cell reselection may comprise a cell reselection at a service level or at a slice level. The first device 110 is further caused to perform: determining whether the slice-based cell reselection is required: and based on determining that the slice-based cell reselection is required, generating the preference information.

In some example embodiments, determining whether the slice-based cell reselection is required based on at least one of the following: a slice type associated with the first device, a device category of the first device, a service area associated with the first device, the service for the first device, a radio coverage, a network capacity, a latency, throughput, and so on.

In some example embodiments, the preference information may be transmitted, as a part of a service profile message, via an interface for an intent on the slice-based cell reselection exposed by the second device 120.

At block 320, the first device 110 transmits the preference information to the second device 120.

In some example embodiments, the first device 110 is further caused to perform: receiving, from the second device 120, an indication of a provisioning status of cell reselection priorities at a service level or at a slice level.

In some example embodiments, the first device 110 may comprise a device acting as a CSC (e.g., a UE), and the second device 120 may comprise a device acting as a CSP (e.g., a gNB).

Additionally, in some example embodiments, the third device 130 may comprise a device acting as a domain orchestrator or network optimization function.

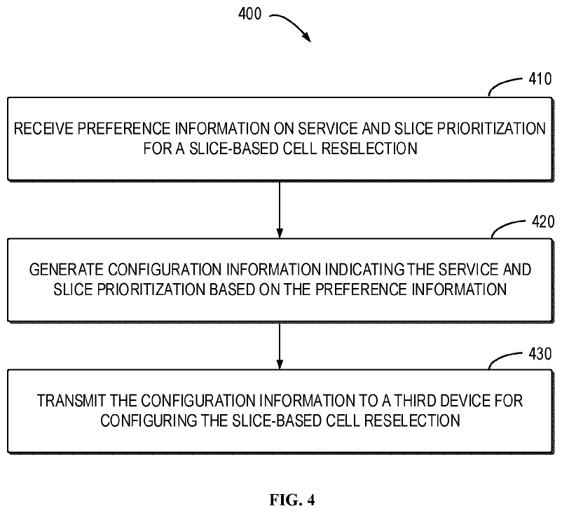

FIG. 4 illustrates a flowchart of an example method 400 implemented at a second device in accordance with some example embodiments of the present disclosure. For example, the second device may include a network device providing a network slice or a communication service for UE. For the purpose of discussion, the method 400 will be described from the perspective of the second device 120 in FIG. 1.

At 410, the second device 120 receives, from the first device 110 served by a slice of the second device 120, preference information on service and slice prioritization for a slice-based cell reselection. In particular, the slice-based cell reselection may comprise a cell reselection at a service level or at a slice level.

In some example embodiments, the preference information may be received, as a part of a service profile message, via an interface for an intent on the slice-based cell reselection exposed by the second device 120.

At 420, the second device 120 generates, based on the preference information, configuration information indicating the service and slice prioritization.

In some example embodiments, the configuration information may indicate a preference for cell selection priorities based on at least one requirement for network performance, and the at least one requirement comprises at least one of the following: a radio coverage, a network capacity, mobility, latency, or throughput.

In some example embodiments, the configuration information may comprise a set of values indicating a preference for cell selection priorities based on a plurality of requirements. The plurality of requirements is prioritized in one of the following an ascending order of the set of values, or a descending order of the set of values. That is, for the former case, the priorities of the requirements increase as the values increase, and the higher the value is, the higher priority the requirement has. For the latter case, the priorities of the requirements increase as the values decrease, and the lower the value is, the higher priority the requirement has.

At 430, the second device 120 transmits the configuration information to a third device 130 for configuring the slice-based cell reselection.

In some example embodiments, the configuration information may be transmitted, as a part of a slice profile message. via an interface for an intent on the slice-based cell reselection exposed by the third device 130.

In some example embodiments, the second device 120 may be further caused to perform: receiving, from the third device 130, an indication of a provisioning status of cell reselection priorities at a service level or at a slice level: and transmitting, to the first device 110, the indication of the provisioning status.

In some example embodiments, the first device 110 may comprise a device acting as a communication service customer, the second device 120 may comprise a device acting as a communication service provider, and the third device 130 may comprise a device acting as a domain orchestrator or network optimization function.

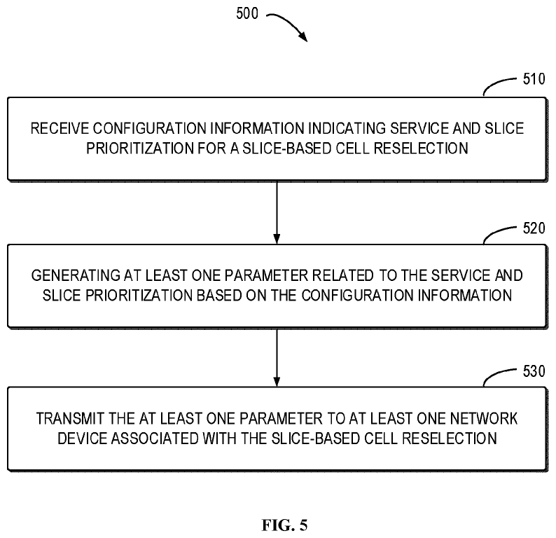

FIG. 5 illustrates a flowchart of an example method 500 implemented at a third device in accordance with some example embodiments of the present disclosure. For example, the third device may include a device implementing a domain orchestrator and/or network optimization function. For the purpose of discussion, the method 500 will be described from the perspective of the third device 130 in FIG. 1.

At block 510, the third device 130 receives, from a second device 120 serving a first device 110 with a slice, configuration information indicating service and slice prioritization for a slice-based cell reselection. In particular, the slice-based cell reselection may comprise a cell reselection at a service level or at a slice level.

In some example embodiments, the configuration information may be received, as a part of a slice profile message, via an interface for an intent on the slice-based cell reselection exposed by the third device 130.

In some example embodiments, the configuration information may comprise a set of values indicating a preference for cell selection priorities based on a plurality of requirements.

The plurality of requirements may be prioritized in one of the following: an ascending order of the set of values, or a descending order of the set of values. That is, for the former case, the priorities of the requirements increase as the values increase, and the higher the value is, the higher priority the requirement has. For the latter case, the priorities of the requirements increase as the values decrease, and the lower the value is, the higher priority the requirement has.

In some example embodiments, the configuration information may indicate a preference for cell selection priorities based on at least one requirement for network performance, and the at least one requirement comprises at least one of the following: a radio coverage, a network capacity, a slice type, mobility, latency, or throughput.

At block 520, the third device 130 generates, based on the configuration information, at least one parameter related to the service and slice prioritization. In some example embodiments, the at least one parameter comprises at least one of the following: a slice specific cell reselection priority, a frequency priority list for NR slicing, etc. For example, the slice specific cell reselection priority may be sliceSpecificCellReselectionPriority, while the frequency priority list for NR slicing may be FreqPriorityListNRSlicing). Additionally, or alternatively, the at least one parameter may comprise the set of values defined for the at least one requirement, such as the radio coverage, the network capacity, the slice type, mobility, latency, throughput and so on.

At block 530, the third device 130 transmits the at least one parameter to at least one network device associated with the slice-based cell reselection.

In some example embodiments, the third device 130 may be further caused to perform: transmitting, to the second device 120, an indication of a provisioning status of cell reselection priorities at a service level or at a slice level.

In some example embodiments, the first device 110 may comprise a device acting as a communication service customer, the second device 120 may comprise a device acting as a communication service provider, and the third device 130 may comprise a device acting as a domain orchestrator or network optimization function.

In some example embodiments, a first apparatus capable of performing any of the method 300 (for example, the first device 110 in FIG. 1) may comprise means for performing the respective operations of the method 300. The means may be implemented in any suitable form. For example, the means may be implemented in a circuitry or software module. The first apparatus may be implemented as or included in the first device 110 in FIG. 1.

In some example embodiments, the first apparatus comprises: means for generating, at the first apparatus served by a second apparatus with a slice, preference information on service and slice prioritization for a slice-based cell reselection; and means for transmitting the preference information to the second apparatus.

In some example embodiments, the preference information indicates a preference for cell selection priorities based on at least one requirement for network performance, and the at least one requirement comprises at least one of the following: a radio coverage, a network capacity, a slice type, mobility, latency, or throughput.

In some example embodiments, the preference information comprises a set of values indicating a preference for cell selection priorities based on a plurality of requirements, and the plurality of requirements is prioritized in one of the following: an ascending order of the set of values, or a descending order of the set of values.

In some example embodiments, the slice-based cell reselection comprises a cell reselection at a service level or at a slice level, and wherein the first apparatus is further caused to perform: determining whether the slice-based cell reselection is required; and based on determining that the slice-based cell reselection is required, generating the preference information.

In some example embodiments, determining whether the slice-based cell reselection is required based on at least one of the following: a slice type associated with the first apparatus, a device category of the first apparatus, a service area associated with the first apparatus, the service for the first apparatus, a radio coverage, a network capacity, a latency, throughput.

In some example embodiments, the preference information is transmitted, as a part of a service profile message, via an interface for an intent on the slice-based cell reselection exposed by the second apparatus.

In some example embodiments, the first apparatus further comprises: means for receiving, from the second apparatus, an indication of a provisioning status of cell reselection priorities at a service level or at a slice level.

In some example embodiments, the first apparatus comprises a device acting as a communication service customer, and the second apparatus comprises a device acting as a communication service provider.

In some example embodiments, a second apparatus capable of performing any of the method 400 (for example, the second device 120 in FIG. 1) may comprise means for performing the respective operations of the method 400. The means may be implemented in any suitable form. For example, the means may be implemented in a circuitry or software module. The second apparatus may be implemented as or included in the second device 120 in FIG. 1.

In some example embodiments, the second apparatus comprises: means for receiving, from a first apparatus served by a slice of the second apparatus, preference information on service and slice prioritization for a slice-based cell reselection; means for generating, based on the preference information, configuration information indicating the service and slice prioritization; and means for transmitting the configuration information to a third apparatus for configuring the slice-based cell reselection.

In some example embodiments, the preference information is received, as a part of a service profile message, via an interface for an intent on the slice-based cell reselection exposed by the second apparatus.

In some example embodiments, the configuration information is transmitted, as a part of a slice profile message. via an interface for an intent on the slice-based cell reselection exposed by the third apparatus.

In some example embodiments, the slice-based cell reselection comprises a cell reselection at a service level or at a slice level.

In some example embodiments, the configuration information indicates a preference for cell selection priorities based on at least one requirement for network performance, and the at least one requirement comprises at least one of the following: a radio coverage, a network capacity, a slice type, mobility, latency, or throughput.

In some example embodiments, the configuration information comprises a set of values indicating a preference for cell selection priorities based on a plurality of requirements, and the plurality of requirements is prioritized in one of the following: an ascending order of the set of values, or a descending order of the set of values.

In some example embodiments, the second apparatus further comprises: means for receiving, from the third apparatus, an indication of a provisioning status of cell reselection priorities at a service level or at a slice level; and means for transmitting, to the first apparatus, the indication of the provisioning status.

In some example embodiments, the first apparatus comprises a device acting as a communication service customer, the second apparatus comprises a device acting as a communication service provider, and the third apparatus comprises a device acting as a domain orchestrator or network optimization function.

In some example embodiments, a third apparatus capable of performing any of the method 500 (for example, the third device 130 in FIG. 1) may comprise means for performing the respective operations of the method 500. The means may be implemented in any suitable form. For example, the means may be implemented in a circuitry or software module. The second apparatus may be implemented as or included in the third device 130 in FIG. 1.

In some example embodiments, the third apparatus comprises: means for receiving, from a second apparatus serving a first apparatus with a slice, configuration information indicating service and slice prioritization for a slice-based cell reselection; means for generating, based on the configuration information, at least one parameter related to the service and slice prioritization; and means for transmitting the at least one parameter to at least one network device associated with the slice-based cell reselection.

In some example embodiments, the slice-based cell reselection comprises a cell reselection at a service level or at a slice level.

In some example embodiments, he configuration information is received, as a part of a slice profile message, via an interface for an intent on the slice-based cell reselection exposed by the third apparatus.

In some example embodiments, the at least one parameter comprises at least one of the following: a slice specific cell reselection priority, a frequency priority list for NR slicing.

In some example embodiments, the configuration information indicates a preference for cell selection priorities based on at least one requirement for network performance, and the at least one requirement comprises at least one of the following: a radio coverage, a network capacity, a slice type, mobility, latency, or throughput.

In some example embodiments, the configuration information comprises a set of values indicating a preference for cell selection priorities based on a plurality of requirements, and the plurality of requirements is prioritized in one of the following: an ascending order of the set of values, or a descending order of the set of values.

In some example embodiments, the third apparatus further comprises: means for transmitting, to the second apparatus, an indication of a provisioning status of cell reselection priorities at a service level or at a slice level.

In some example embodiments, the first apparatus comprises a device acting as a communication service customer, the second apparatus comprises a device acting as a communication service provider, and the third apparatus comprises a device acting as a domain orchestrator or network optimization function.

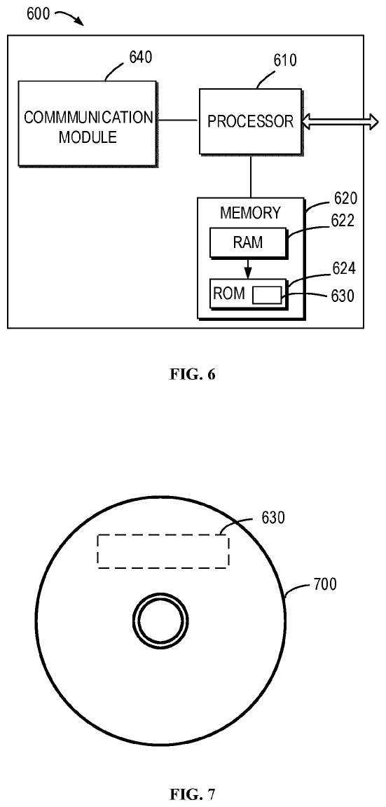

FIG. 6 is a simplified block diagram of a device 600 that is suitable for implementing example embodiments of the present disclosure. The device 600 may be provided to implement an electronic device, for example, the first device 110, the second device 120, or the third device 130 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 1 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

PARTIAL GLOSSARY

| | |
|---|---|
| 3GPP | Third Generation Partnership Project |
| CSC | Communications Service Customer |
| CSP | Communications Service Provider |
| UE | User Equipment |
| 5G | Fifth Generation |
| CN | Core Network |
| RAN | Radio Access Network |
| LTE | Long Term Evolution |
| LTE-A | LTE-Advanced |
| WCDMA | Wideband Code Division Multiple Access |
| HSPA | High-Speed Packet Access |
| NB-IoT | Narrow Band Internet of Things |
| NR | New Radio |
| BS | Base Station |
| AP | Access Point |
| eNodeB | Evolved NodeB |
| gNB/NR NB | Next Generation NodeB |
| RRU | Remote Radio Unit |
| RH | Radio Header |
| RRH | Remote Radio Head |
| CU | Centralized Unit |
| DU | Distributed Unit |
| SS | Subscriber Station |
| MS | Mobile Station |
| AT | Access Terminal |
| VoIP | Voice over IP |
| PDA | Personal Digital Assistant |
| LEE | Laptop-embedded Equipment |
| LME | Laptop-mounted Equipment |
| USB | Universal Serial Bus |
| CPE | Customer-Premises Equipment |
| HMD | Head-mounted Display |
| MT | Mobile Termination |
| IAB | Integrated Access and Backhaul |
| DL | Downlink |
| UL | Uplink |
| Tx | Transmitting |
| Rx | Receiving |
| ID | Identity/Identifier |
| IEEE | Institute for Electrical and Electronics Engineers |
| CDMA | Code Division Multiple Access |
| FDMA | Frequency Division Multiple Access |
| TDMA | Time Division Multiple Access |
| FDD | Frequency Division Duplex |
| TDD | Time Division Duplex |
| MIMO | Multiple-Input Multiple-Output |
| OFDM | Orthogonal Frequency Division Multiple |
| DFT-s-OFDM | Discrete Fourier Transform spread OFDM |
| IoT | Internet of everything |
| eMTC | enhanced Machine-Type Communication |
| URLLC | Ultra Reliable Low Latency Communications |
| eMBB | Enhanced Mobile Broadband |
| mMTC | Massive Machine Type Communications |

1. A first device, comprising:
at least one processor; and
at least one memory storing instructions that, when executed by the at least one processor, cause the first device at least to perform:
generating, at the first device served by a second device with a slice, preference information on service and slice prioritization for a slice-based cell reselection; and
transmitting the preference information to the second device.

2. The first device of claim 1, wherein the preference information indicates a preference for cell selection priorities based on at least one requirement for network performance, and the at least one requirement comprises at least one of the following: a radio coverage, a network capacity, a slice type, mobility, latency, or throughput.

3. The first device of claim 2, wherein the preference information comprises a set of values indicating a preference for cell selection priorities based on a plurality of requirements, and the plurality of requirements is prioritized in one of the following:
an ascending order of the set of values, or
a descending order of the set of values.

4. The first device of claim 1, wherein the slice-based cell reselection comprises a cell reselection at a service level or at a slice level, and wherein the first device is further caused to perform:
determining whether the slice-based cell reselection is required; and
based on determining that the slice-based cell reselection is required, generating the preference information.

5. The first device of claim 4, wherein determining whether the slice-based cell reselection is required based on at least one of the following: a slice type associated with the first device, a device category of the first device, a service area associated with the first device, the service for the first device, a radio coverage, a network capacity, a latency, throughput.

6. The first device of claim 1, wherein the first device is further caused to perform:
receiving, from the second device, an indication of a provisioning status of cell reselection priorities at a service level or at a slice level.

7. The first device of claim 1, wherein the first device comprises a device acting as a communication service customer, and the second device comprises a device acting as a communication service provider.

8. A second device, comprising:
at least one processor; and
at least one memory storing instructions that, when executed by the at least one processor, cause the second device at least to perform:
receiving, from a first device served by a slice of the second device, preference information on service and slice prioritization for a slice-based cell reselection;
generating, based on the preference information, configuration information indicating the service and slice prioritization; and
transmitting the configuration information to a third device for configuring the slice-based cell reselection.

9. The second device of claim 8, wherein the preference information is received, as a part of a service profile message, via an interface for an intent on the slice-based cell reselection exposed by the second device.

10. The second device of claim 8, wherein the slice-based cell reselection comprises a cell reselection at a service level or at a slice level.

11. The second device of claim 8, wherein the configuration information indicates a preference for cell selection priorities based on at least one requirement for network performance, and the at least one requirement comprises at least one of the following: a radio coverage, a network capacity, a slice type, mobility, latency, or throughput.

12. The second device of claim 11, wherein the configuration information comprises a set of values indicating a preference for cell selection priorities based on a plurality of requirements, and the plurality of requirements is prioritized in one of the following:
an ascending order of the set of values, or
a descending order of the set of values.

13. The second device of claim 8, wherein the second device is further caused to perform:
receiving, from the third device, an indication of a provisioning status of cell reselection priorities at a service level or at a slice level; and
transmitting, to the first device, the indication of the provisioning status.

14. The second device of claim 8, wherein the first device comprises a device acting as a communication service customer, the second device comprises a device acting as a communication service provider, and the third device comprises a device acting as a domain orchestrator or network optimization function.

15. A third device, comprising:
at least one processor; and
at least one memory storing instructions that, when executed by the at least one processor, cause the third device at least to perform:
receiving, from a second device serving a first device with a slice, configuration information indicating service and slice prioritization for a slice-based cell reselection;
generating, based on the configuration information, at least one parameter related to the service and slice prioritization; and
transmitting the at least one parameter to at least one network device associated with the slice-based cell reselection.

16. The third device of claim 15, wherein the slice-based cell reselection comprises a cell reselection at a service level or at a slice level.

17. The third device of claim 15, wherein the configuration information is received, as a part of a slice profile message, via an interface for an intent on the slice-based cell reselection exposed by the third device.

18. The third device of claim 15, wherein the at least one parameter comprises at least one of the following:
a slice specific cell reselection priority,
a frequency priority list for NR slicing.

19. The third device of claim 15, wherein the configuration information indicates a preference for cell selection priorities based on at least one requirement for network performance, and the at least one requirement comprises at least one of the following: a radio coverage, a network capacity, a slice type, mobility, latency, or throughput.

20. The third device of claim 19, wherein the configuration information comprises a set of values indicating a preference for cell selection priorities based on a plurality of requirements, and the plurality of requirements is prioritized in one of the following:
an ascending order of the set of values, or
a descending order of the set of values.

21.-29. (canceled)
